(19) United States
(12) Patent Application Publication
(10) Pub. No.: US 2008/0092988 A1
(43) Pub. Date: Apr. 24, 2008

(54) Finger Joint

(76) Inventor: Tuomo Poutanen, Tampere (FI)

Correspondence Address: STITES & HARBISON PLLC, 1199 NORTH FAIRFAX STREET, SUITE 900, ALEXANDRIA, VA, 22314, US

(21) Appl. No.: 11/720,386

(22) PCT Filed: Nov. 28, 2005
(86) PCT No.: PCT/FI05/00512

§ 371 Date: May 29, 2007

(30) Foreign Application Priority Data
Nov. 29, 2004 (FI) 20041529

(51) Int. Cl. B27D 1/00; B25G 3/02

(52) U.S. Cl. 144/347; 403/364

(57) ABSTRACT

A finger joint in a joint assembled of at least mainly woody parts (1, 2), such as sawn timber, glued wood, plywood, fibreboard, LVL, LSL, comprises at least one finger The finger shapes needed complementarily have been milled with a cutting tool, such as a milling curser, to the both parts (1, 2). The height of at least one complementary pair of fingers varies along the length of the interlocking finger pair.

### FIELD OF INVENTION

The invention relates to a finger joint according to the preamble of claim 1 and a method according to the preamble of claim 8.

### BACKGROUND

The use of finger joints in timber joints is common. However, some problems are connected to these joints.

One problem is that the fingers remain visible on all sides, but usually they are visible at least on two sides. The visible fingers cause many kinds of problems. They are an esthetical disturbance. Usually they cannot be painted without rough working as grinding and filling. From visible fingers water and dirt can harmfully penetrate into the wood.

Another disadvantage connected to finger joints is that the finger grooves reach outside the joint. Such a finger joint solution is presented among others in publication U.S. Pat. No. 3,452,502. From connection pieces material is removed outside the joint area, which reduces the firmness. The fingers outside the joint are aesthetically bad and in addition water and dirt can harmfully gather in them. Also such a problem is connected to the finger joints that by assembly the joints are difficult to locate. Finger cuttings do not locate the connection pieces accurately in regard to each other.

Present finger joints are not in an optimal way firm, since they have structural discontinuities, which cause great local tensions.

### SUMMARY OF INVENTION

By means of the invention one can get rid of the above described problems. The new joint is better than the former one, especially more extensive as to its field of embodiments, to its visual quality of higher level and firmer, especially a finger joint, the fingers of which are invisible and from the connection pieces no material is removed outside the joint area. The joint according to the invention is characterized in what is defined in the preamble of claim 1 and the method in what is defined in the preamble of claim 8.

In this invention some known technologies are used:
The joint is made by cutting complementary fingers between the pieces, usually advantageously those narrowing towards the tip.
Glue is put in the fingers and they are pressed together. In special cases there are in the joint also nails, screws or other joining means. The purpose of them can be strengthening of joint or to facilitate the manufacture. In another in a special case, when the firmness of joint is secondary or when the joint is made under conditions, where the use of glue is not possible, as outside the factory conditions, there is no glue in the joint nor other joining means, whereby the joint is formed merely through the contact of joint surfaces.
The fingers in the pieces to be connected can be similar, so both the pieces to be connected can be cut with the same cutter only changing the location of the cutter in regard to the connection pieces. However, usually the fingers in connection pieces can be different, whereby two different cutters are needed—mail cutter and female cutter.

In this invention some new solutions are applied:
The heights of fingers vary. The fingers are at their lowest in the joint ends or at least in the other end. The variation of the height of fingers is produced so that the cutter is moved farther from the connection piece to be cut. Usually this means that in addition to the cutting direction the cutter is steered also in the transverse direction. Alternatively the connection piece can in regard to the cutter be moved into place or both of them move. Usually there are in the joint many fingers side by side and often the heights of these parallel fingers vary in the same way in the cutting direction, but it is also possible that the heights of the parallel fingers vary differently. Usually it is advantageous that the fingers on the edges of the joint area are short, e.g. the fingers are short in the beginning and end of cuttings and that the outermost fingers are short.
Usually the height of fingers is in the ends of cuttings fitted to zero. From a solution like this many advantages are achieved: The fingers are invisible and the joint is visually of high quality. In present solutions the finger grooves are partly outside the joint area, whereby these grooves are nests of dirt and water. The new joint is firm, because wood is not cut at all outside the joint area. Great firmness is also achieved, because the height of fingers gets gradually shorter, so in the joint end no great tension peaks appear.
During cutting the cutter is steered along the cutting line about least in the cutting ends often also in the middle.
The cutter has a small diameter. The smaller the cutter the more versatile joints can be made by it. In some cases, for instance when one connection piece is thicker than the other, it is advantageous to carry out cutting of the one with a small cutter and the other with a great one. Then the smaller cutter is usually as small as possible.
Usually the joint surface is rough-worked before finger cutting into a crooked level, which corresponds to tips to be cut. This can be made which the fingers are cut in moving the cursor in the direction of with a separate cylinder cutter or the same finger cursor by means of the axle.
When great firmness is required of the joint, the fingers are strongly narrowing towards the tip. In a joint like this the cutter is in the cutting ends steered perpendicular in regard to the cutting direction, i.e. in the direction of the cutting tool. Alternatively the piece to be cut moves and the cutter stays put or both of them move. Further, the cutting tool can also be circulated. This method is especially useful, if at a time only one finger is cut. The shape of the finger in the joint end is different compared with the fingers in the middle, they are lower, the finger bottoms broader and tips narrower, e.g. with one cutter of the cutting tool many fingers of different shapes can be achieved, i.e. the cutter of the cutting tool cuts a finger groove either as broad as this cutter or one variably broader, and the finger so formed is shorter.
The connection gaps according to the joint of this invention change more than conventional joints, among others because of the inaccuracy of cutting. Therefore it is advantageous to use glue in the joint. It works in quite big connection gaps, even big connection gaps of size 0.6 mm.

List of figures according to the enclosed drawing

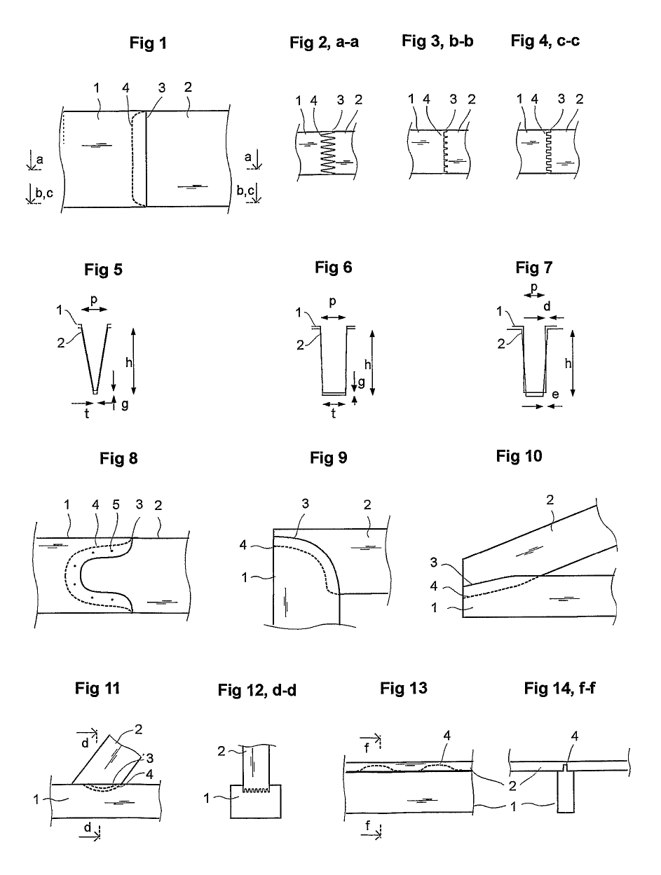

FIGS. 1, 2, 3, 4 a joint of two pieces of wood, sections a-a, b-b, c-c

FIGS. 2, 5, 6, 7, different types of fingers

FIG. 8, a joint with crooked cutting groove

FIGS. 9, 10 angle joints

FIGS. 11, 12. T-joint of pieces of thickness

FIGS. 13, 14 joint of wooden piece and board

### DETAILED PRESENTATION OF INVENTION

FIG. 1 shows a finger joint of two wooden pieces 1 and 2, and FIGS. 2 and 3 show sections a-a, and b-b and FIG. 4 an alternative section c-c. In this case the joint is made so that seam line 3, visible on the outer surface, is straight, but in some cases it is advantageous that the seam line is crooked. The joint is made advantageously so that part 1 is cut along line 3 usually advantageously with a normal saw. The end of part 2 line is shaped according to line 4 for instance by means of a cylinder cursor or usually advantageously by means of the finger cursor moving it in the direction of the axle. The joint in the middle is a normal finger joint, FIG. 2, where the finger is narrowing towards the tip, In the case of FIG. 3 the fingers in the ends of cuttings of part 2 get shorter and also broader, which is achieved moving the cutter in the direction of the axle. By working part 2 the cutting tool is not moved in the direction of the axle. A solution like this is in many respects usable: Working of fingers is simple. The firmness is great, taken into consideration that the broader fingers are fitted on the critical side. In some cases the cutter cannot be moved at all in the direction of the axle. Alternatively the fingers of parts 1 and 2, FIG. 4, are cut get broader in the same way. A solution like this is very good by joint assembling, the fingers do not break easily and the parts are easily and accurately located in regard to each other. If one wants to get high quality cutting edges the direction of rotation of the cutting tool cutting is in the cutting ends fitted in the direction of the cutting tool i.e. so called counter feeding, i.e. the of the cutting tool rotation of the cutting tool is different in the different ends of the cutting groove.

FIG. 5 shows a conventional narrowing complementary pair of fingers between connecting pieces 1 and 2, which is formed of the male finger of part 1 and the female finger of part 2. Such a finger is well fitted to points, where great firmness is needed. In glulam joints the finger height h is usually h≈3 . . . 50 mm, the finger tip t≈0.5 . . . 2 mm, the glue groove g depending on glue and it is usually≈0.1 . . . 1 mm. The finger bottom is usually chosen so that h/p≈3 . . . 6. The number of fingers is usually fitted as large as possible, i.e. the distribution of fingers is p+t. Usually the outermost edges are different from others, since by means of those fingers the edge of joint is shaped by ways aesthetically known to be of high quality.

FIG. 6 shows a straight or a little narrowing finger towards the tip. The cutters of parts 1 and 2 are as to their shape fitted as such so that in regard to the assembly a sufficient gap is formed in the finger joint and that the woody pieces are not compressed at all or only a little, so little that by assembly a joint tight enough is achieved by means of a small compression force without breaking the connecting pieces. By the production of such a joint the fingers of different size can be made without sideways motion of the cursor.

FIG. 7 shows a joint, where the finger of part 1 is straight and the finger of part 2 slightly narrowing towards the tip. Such fingers are suited for glulam joints, when in the finger bottoms a small play d is fitted, which usually is smaller than about 0.6 mm and, in addition, smaller than the greatest glue gap allowed for used glue. The joints lock by assembly, when the finger profiles are fitted to such ones that the fingers are tight in the tips or compressed some small measure e.

FIG. 8 shows a joint, where the cutting line is a U-shaped curve. By means of a solution like this the face of joint grows and at the same time also the firmness compared to the fact that the cutting face is straight. Yet a greater glue face and smaller wastage of material is reached if the cutting has the shape of letter S, or the cutting is slanting with respect to the connecting pieces. This kind of joint works without glue and even without any other joining means, if the joint is effected only by compression stress. If the joint is effected by a relatively small tension stress, as joining means in the joint there can be only nails or screws 5 at the same time.

FIG. 9 shows an angle joint, where the fingers shorten only in the concave corner. Such a solution is especially advantageous if the joint is strained by a moment, which causes compression in the concave corner. The cutting line is curved, so the joint length is greater if the cutting were straight. The cutting line can also have the shape of letter S or serrate. By means of the shape of cutting it is possible to adjust the firmness of joint and other properties as wanted. The cutting according to the figure is advantageous if part 1 is firmer or as to its crosscut greater.

FIG. 10 shows the angle joint of two wooden bars 1 and 2. It is essential that the cutting line is in he direction of neither bar but deviates from the directions of the bars as much as possible, i. e. the cutting line is advantageously approximately in the direction of the half the joint angle. A good result is also achieved so that cutting is as little as possible in the direction of the bars or as close as possible to the half of the joint angle. If no glue is used in the joint but for instance screws, nails etc., the joint area ought to be made as big as possible, whereby it is advantageous to carry out cutting so that the cutting grooves are straight extensions of the border line of the other part.

FIGS. 11, 12 show a T-joint of two pieces of different thickness. The finger is narrowing. The cutter cannot be moved sideways by cutting the fingers of part 1, so the fingers must be shaped just right by cutting of part 2. This example illustrates that the joint needs not to reach wholly the area of the connection piece. Among others, a solution like this is usable when the corner of joint is wanted to be of high class so that it has no splits, cutting errors etc. caused by cutting. Correspondingly, the joint can be greater than the connected bar.

FIGS. 13 and 14 show the joint of board 2 and woody piece 1. The board is thin, so the finger cannot be continuous, because it would weaken the board too much. When the finger is intermittent, as shown in the figures, about half of the board can be without finger grooves. In such a case part 1 can be of timber but usually advantageously in the shape of a truss, serrate sawn or cut LVL, plywood etc. The finger shape shown in FIG. 7 is especially efficient, when the finger of part 1 is straight, usually advantageously made so that this part has no separate finger, but the edge of part 1 is milled or cut in shape of the female finger of part 2. Alternatively there is in part 1 a finger narrowing towards the finger tip, which for simplification of manufacture is worked outside the joining area, whereby moving of the cutter in the direction of the axle is not needed.

Above some embodiments of the invention are presented. The inventive concept can be applied even in other ways within the limits of the claims.

1. A finger joint for example glued finger joint connected to a joint assembled at least mainly of woody parts as timber, laminated timber, plywood, chip-board, fibreboard, LVL, LSL, which has at least one finger, where in both said parts by means of a cutting tool, as a cursor, complementarily needed finger shapes are cut, characterized in that the height of at least one complementary finger-notch pair changes in the cutting direction.

2. A joint according to claim 1 characterized in that the height of the finger is shorter in the joint ends than in the middle of the joint, for instance the height is zero, whereby the finger in joint corner is invisible.

3. A joint according to claim 1 characterized in that the fingertip has different widths (t).

4. A joint according to claim 3 characterized in that the turnover of the fingertip width (t) is carried out with the steering of the cutter in the direction of its axle.

5. A joint according to claim 4 characterized in that in the joint corner shortening of fingers and thickening of tips are fitted to take place only in the other connecting piece or shortening and widening of fingers are fitted to take place in both connecting pieces roughly in the same way.

6. A joint according to claim 1 characterized in that at least one of the connecting pieces is cut with a cutting tool, the diameter of which is small, smaller than 50 mm plus the height of fingers, advantageously smaller than 25 mm plus the height of fingers.

7. A method to manufacture a complementary finger joint of woody parts by means of a cutting tool rotating around its axle, as a cursor, characterized in that the change of the finger height is achieved by steering the cutting tool in the direction of the cutting also against this direction, i.e. perpendicularly in the direction of its axle.

8. A method according to claim 8 characterized in that the cutting tool is steered for shortening and/or broadening the complementary finger pair in the ends of the joint.
